(19) United States
(12) Patent Application Publication
(10) Pub. No.: US 2006/0225738 A1
(43) Pub. Date: Oct. 12, 2006

(54) In-mouth filtration apparatus

(76) Inventor: Chris Afentoulopoulos, London (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(21) Appl. No.: 11/298,703

(22) Filed: Dec. 12, 2005

(30) Foreign Application Priority Data
Apr. 6, 2005 (CA) 2,508,524

(51) Int. Cl. A62B 23/02; A62B 7/10

(52) U.S. Cl. 128/205.27; 128/205.29; 128/206.11; 128/206.12; 128/206.17; 128/207.29; 128/207.13; 128/207.18; 128/201.25; 128/201.26; 128/848; 128/859; 128/861; 128/863

(57) ABSTRACT

An in-mouth filtration apparatus, for example for use in sunless liquid-spray tanning to prevent the inhalation of liquid droplets, particles, and/or toxic gases. The filtration apparatus includes a mouthpiece having a curved portion with protrusions for biting upon. This permits the apparatus to be held in place with the jaw in a substantially closed position, thereby reducing the required lip and jaw pressure and improving the comfort and safety of the user. An interchangeable and disposable filtration insert permits airflow only through an end opening which comprises a plurality of holes. A second chamber for receiving such interchangeable inserts may contain additional filtration material.

### FIELD OF THE INVENTION

The invention relates to in-mouth filters designed to utilize disposable or interchangeable cartridges containing a filtering material for use in environments where particular pollutants in the air, such as paint particles or tanning spray, are required to be prevented from entering the mouth or throat of the user while breathing through the mouth. The filtration device is light and fits comfortably into the mouth of the user and the filtration process occurs outside the mouth.

### BACKGROUND OF THE INVENTION

Filtration masks are well known in the art.

The usual way in which such masks operate is by attaching a filter element over the nose and mouth of the wearer. In some instances, the mask also provides protection for the user's eyes. It is also the usual way of operation of such masks that they be fitted around the circumference of the user's head, affixed either by straps or elastic. Some filters have included an element imbued with or covered by a coating to further reduce the transmission of toxic gases.

In applications such as sunless liquid spray tanning, it is desirable that the filtration apparatus not obstruct the face in order to ensure uniform application of the tanning materials. The prior art filter masks are large and generally operate on the basis of sealing the area around the lower portion of the face, providing for a fabric or screen to prevent certain particles or gases from entering the nose and/or throat of the user while still allowing for the user to breathe freely. These types of filter masks are therefore not suitable in liquid spray tanning applications.

U.S. patent application Ser. No. 10/924,682, filed Aug. 23, 2004 by Botzen discloses an in-mouth filter for sunless liquid spray tanning. This apparatus lacks a mouthpiece for facilitating placement of the apparatus within the user's mouth and relies upon continuous lip and jaw pressure open a large oval pipe to retain the apparatus in place. Since the user's jaw is required to be held in a substantially open position while the filtration apparatus is in use, it is often difficult for users to maintain continuous lip and jaw pressure for the duration of a liquid spray tanning session. As a result, users experience significant discomfort.and the filter can slip out of position due to jaw fatigue, potentially endangering the user due to inhalation of toxic liquid spray tanning particles.

There is therefore a need to improve upon the ergonomics and safety of prior art in-mouth filters.

It is an object of the present invention to provide a novel filtration device for use in light industrial or commercial situations, such as in liquid spray tanning.

It is another object of the present invention to provide a small and lightweight filtration device that prevents foreign particles and/or toxic gases from being inhaled while still allowing for easy breathing through the mouth.

It is yet another object of the invention to improve upon the ergonomics and safety of prior art filters by making them more easily held within the mouth and to thereby reduce jaw fatigue.

It is still another object of the invention is to provide for an interchangeable and disposable filter that may be disposed of after one use in order to maintain the integrity and cleanliness of the filtering material therein and the hygienic properties of the filter relative to other instances found in the prior art.

### SUMMARY OF THE INVENTION

According to an aspect of the present invention, there is provided a filtration apparatus for insertion within the mouth of a user, the apparatus comprising: a filter insert with an end opening comprising at least one hole for admitting air into the apparatus, the filter insert having a diameter; a filtering material located within the filter insert and spanning the diameter, the filtering material permitting the passage of air while preventing the passage of particles therethrough; and, a mouthpiece having a mouthpiece opening permitting the passage of air therethrough in fluidic communication with the filter insert, the mouthpiece having a curved portion corresponding in size to the user's lips.

When in use, the mouthpiece is within the user's mouth and the curved portion may be retained beneath the user's lips. The mouthpiece may comprise two or more protrusions for biting upon by the user to thereby hold the apparatus within the user's mouth.

The apparatus may further comprise a receiving compartment permitting the passage of air therethrough secured to the filter insert and the mouthpiece.

The present invention advantageously improves upon the ergonomic and safety characteristics of prior art in-mouth filters by providing a mouthpiece that permits passive retention of the filtration apparatus within the user's mouth while facilitating gripping by the user's teeth with minimal jaw pressure and with the jaws in a substantially closed position, thereby reducing the likelihood of jaw fatigue.

The present invention is placed directly into the mouth and there is no need for straps or other means of affixing the filter to the head; thus, it is not a mask as is known in the prior art.

A removable insert may be used to house the filtering material in a solid housing or cartridge, through which the user may breathe without allowing for the passage of unwanted particles. The cartridge allows the filtering material to be readily removed or replaced. The replaceability and interchangeability of the filtering material also affords the user the ability to increase or decrease the level of filtration required. Users may adjust the level of filtration desired for the density of the particles being filtered away from the throat.

The filtering material may be any suitable material for permitting the passage of air and preventing the passage of particles, such as liquid spray tanning droplets. For example, the filtering material may comprise a filter cloth, a pleated or folded pad, a non-woven fibre, a fibrous material, or any other suitable material. The filtering material and/or an additional filtering material may prevent the passage of toxic gases and may include, for example, charcoal or other solid-phase adsorbents that permit the passage of air therethrough.

The present invention is preferably readily sterilized and may be provided in a pre-sterilized package. The present invention is easily transported and convenient to use for short-term use.

### BRIEF DESCRIPTION OF THE DRAWINGS

Having summarized the invention, embodiments thereof will now be described with reference to the accompanying figures, in which:

FIG. 1 is a side cross-sectional view of a filter insert, a filtering material and a compartment according to an embodiment of the present invention;

FIG. 2 is an end view of the filter insert pictured in FIG. 1;

FIG. 3 is a side cross-sectional view of the filter insert, filtering material and compartment pictured in FIG. 1 with the filter insert separated from the compartment;

FIG. 4 is a perspective view of a mouthpiece according to an embodiment of the present invention;

FIG. 5 is a side cross-sectional view of an embodiment of the invention when fully assembled and ready for use;

FIG. 6 is another perspective view of the mouthpiece pictured in FIG. 4; and,

FIG. 7 is a perspective view of a mouthpiece and filter insert according to another embodiment of the invention.

### DESCRIPTION OF PREFERRED EMBODIMENTS

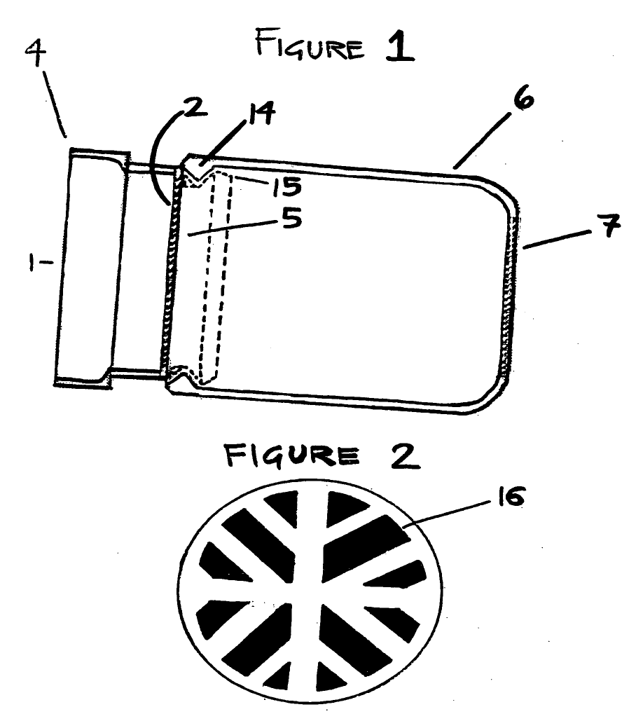

Referring to the drawings, in which corresponding elements are identified throughout with the same reference numeral, and more particularly to FIGS. 1 to 3, wherein the filtering component of the present invention is identified generally in two parts, the filter insert 4 and the receiving compartment 6, both of which are, in this embodiment, constructed out of polypropylene.

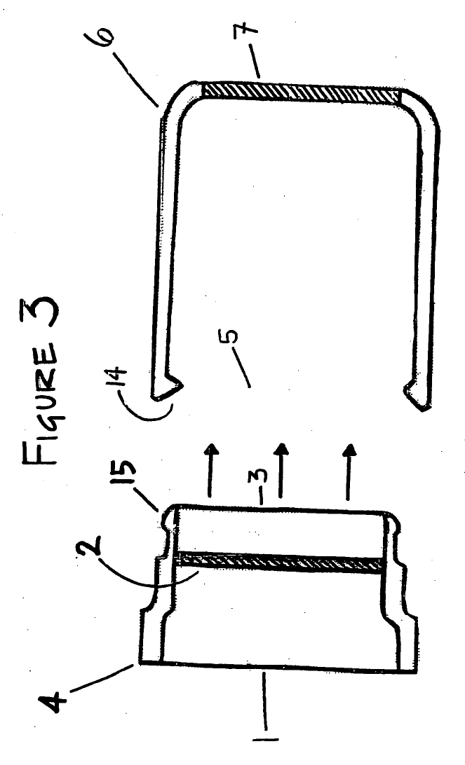

The filter insert 4 is hollow with the exception of the filtering material 2. The filtering material 2 completely spans the diameter of the filter insert 4 approximately 0.25 inches from the opening 1 of the filter insert and allows only certain particles to pass successfully into the top 5 of the receiving compartment 6. The opening 1 of the filter insert 4 is illustrated in greater detail in FIG. 2 and contains a plurality of holes 16 that may be arranged in any design by those skilled in the art, through which air may pass while larger particles are prevented from passing into the filter insert 4.

The end 3 of the filtration insert 4 allows the passage of air into the receiving compartment 6 and includes an outward-facing lip 15 running along the perimeter of the insert. This forms a recess for receiving a similar inward-facing lip 14 of the receiving compartment 6. The filter insert 4 is held securely in place when inserted within the receiving compartment 6 by having the outward-facing lip 15 lock into place under the inward-facing lip 14 of the receiving compartment 6; this secures the insert 4 in fluidic connection to the rest of the invention.

Additional filtering material 7 may also be provided at the bottom of the receiving compartment 6 in the event that additional filtration is required. The additional filtering material 7 may be provided to prevent toxic gases from passing through the filtration apparatus.

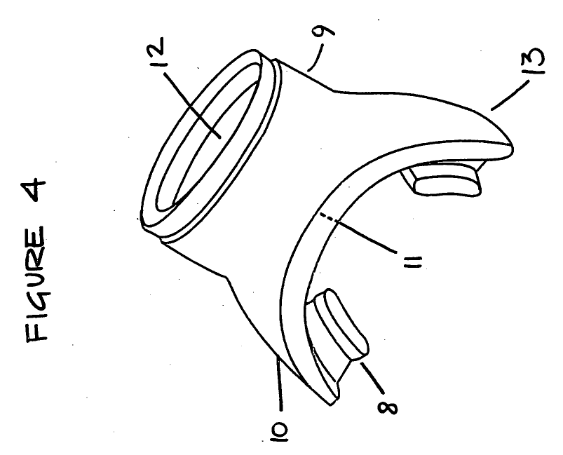

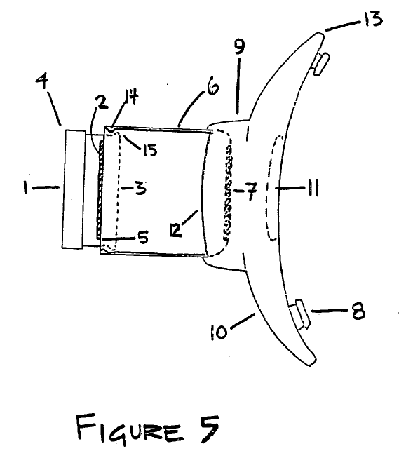

Turning now to FIGS. 4 and 6, wherein the portion of the instant invention that is placed in the user's mouth is illustrated, the aperture into which the filter insert 4 is inserted is indicated at 12. The mouthpiece illustrated in FIG. 4 is, in one embodiment, made of rubber in order to form a closed seal around the perimeter of the receiving compartment 6 when placed within the aperture 12. The mouthpiece extends outward in a curved shape to allow the mouthpiece to be placed beneath the user's lips with the mouth being closed around the curved portion 10. The curved portion 10 corresponds in size to the user's lips and allows the mouthpiece to be passively retained in the mouth with relatively little lip or jaw pressure. The mouthpiece may be further held in place by biting upon each of the two protrusions 8 extending outward from the curved portion 10 of the mouthpiece, the protrusions 8 then being held between the user's teeth. This allows the mouthpiece to be firmly held in place with the jaw in a substantially closed position, thereby reducing the likelihood of jaw fatigue and improving the comfort and safety of the filtration apparatus.

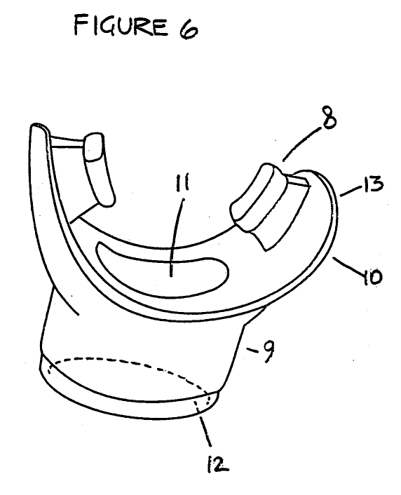

The final construction of this embodiment of the invention, as depicted in FIG. 5, has the filter insert 4 locked into the receiving compartment 6, with the receiving compartment 6 then securely fastened into the aperture 12 of the mouthpiece and the curved portion 10 of the mouthpiece then placed into the user's mouth and secured by biting upon the two protrusions 8. Airflow is facilitated into the breathing passage of the user by having air pass through the opening 1 of the filter insert 4, as illustrated in FIGS. 1 to 3, through the filtering material 2, through the hollow receiving compartment 6, passing through the outward-extended portion of the mouthpiece 9 for receiving the compartment 6, and into the breathing passage of the user through the hollow opening 11 in the mouthpiece. Inhalation of filtered oxygen and exhalation are both possible in this embodiment.

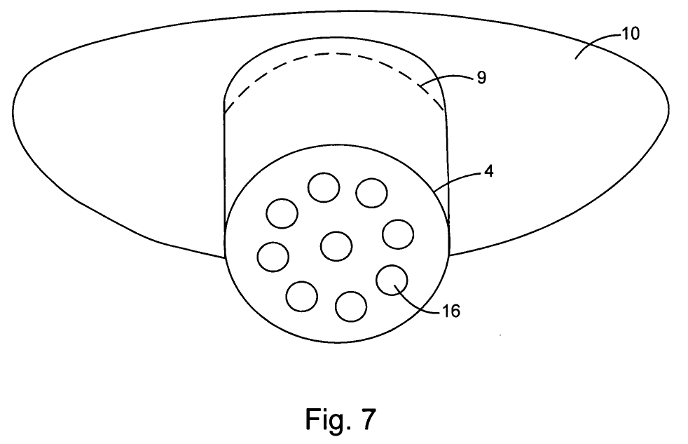

In another embodiment, depicted in FIG. 7, the receiving compartment 6 is omitted and the filter insert 4 is secured directly to the mouthpiece, for example by friction-fit over the extended portion 9 of the mouthpiece. In this embodiment, the protrusions 8 may be omitted and the curved portion 10 of the mouthpiece may simply be held by the lips. Air is admitted into the apparatus through the plurality of end holes 16 in the filter insert 4. In this embodiment, both the mouthpiece and filter insert are formed from a material compatible with spray tanning fluids, for example a plastics material such as polypropylene or polyethylene.

The above-described embodiments of the invention are intended to be examples of the present invention and alterations and modifications may be effected thereto, by those of skill in the art, without departing from the scope of the invention which is defined solely by the claims appended hereto.

1. A filtration apparatus for insertion within the mouth of a user, the apparatus comprising:
a) a filter insert with an end opening comprising at least one hole for admitting air into the apparatus, the filter insert having a diameter;
b) a filtering material located within the filter insert and spanning the diameter, the filtering material permitting the passage of air while preventing the passage of particles therethrough; and,
c) a mouthpiece having a mouthpiece opening permitting the passage of air therethrough in fluidic communication with the filter insert, the mouthpiece having a curved portion corresponding in size to the user's lips.

2. The apparatus according to claim 1, wherein, when in use, the mouthpiece is within the user's mouth and the curved portion is retained beneath the user's lips.

3. The apparatus according to claim 2, wherein the mouthpiece comprises two or more protrusions for biting upon by the user to thereby hold the apparatus within the user's mouth.

4. The apparatus according to claim 3, wherein the apparatus further comprises a receiving compartment permitting the passage of air therethrough secured to the filter insert and the mouthpiece.

5. The apparatus according to claim 4, wherein the filter insert comprises an outward-facing lip, the receiving compartment comprises an inward-facing lip, and the filter insert is secured within the receiving compartment by locking of the outward-facing lip with the inward-facing lip.

6. The apparatus according to claim 4, wherein an additional filtering material is provided within the receiving compartment.

7. The apparatus according to claim 6, wherein the filtering material and/or the additional filtering material prevents the passage of toxic gases therethrough.

8. The apparatus according to claim 1, wherein the filtering material is provided within a disposable cartridge.

9. The apparatus according to claim 1, wherein the filtering material is removable and replaceable.

10. The apparatus according to claim 1, wherein the filter insert comprises a plurality of holes.

11. The apparatus according to claim 10, wherein the plurality of holes is arranged to permit air to pass therethrough while preventing larger particles from passing therethrough.

12. The apparatus according to claim 1, wherein the mouthpiece is made from a resilient material suitable for sealing.

13. The apparatus according to claim 1, wherein the apparatus permits inhalation and exhalation of air therethrough.

14. The apparatus according to claim 1, wherein the filter insert, filtering material and mouthpiece are made from materials compatible with spray tanning fluids.

15. The apparatus according to claim 1, wherein the mouthpiece and filter insert are made from a plastics material.

16. The apparatus according to claim 1, wherein the mouthpiece and filter insert are made from polypropylene.
